(19) United States
(12) Patent Application Publication
(10) Pub. No.: US 2005/0198683 A1
(43) Pub. Date: Sep. 8, 2005

(54) Analog and digital broadcasting receiver

(75) Inventor: Eung-sun Kim, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/989,457

(22) Filed: Nov. 17, 2004

(30) Foreign Application Priority Data
Mar. 8, 2004 (KR) 2004-15587

(51) Int. Cl. H04N 7/173; H04N 7/16

(52) U.S. Cl. 725/100; 725/131; 725/139; 725/151

(57) ABSTRACT

An analog and digital receiver includes an analog broadcasting receiver section for receiving and reproducing analog broadcasting signals, and a digital broadcasting receiver section for receiving and reproducing digital broadcasting signals, which receiver sections are installed within a single housing. The analog and digital receiver include an analog tuner for selecting an analog broadcasting and a digital tuner for selecting a digital broadcasting, wherein an output stage of the digital tuner is wire-connected to an input stage of the analog tuner or an output stage of the analog tuner is wire-connected to an input stage of the digital tuner.

### CROSS-REFERENCE TO RELATED APPLICATION

This application claims the benefit of Korean Patent Application No. 2004-15587, filed on Mar. 8, 2004 in the Korean Intellectual Property Office, the disclosure of which is incorporated herein by reference in its entirety.

### BACKGROUND OF THE INVENTION

1. Field of the Invention

The present invention relates to an analog and digital broadcasting receiver, which is capable of receiving both of analog and digital broadcastings.

2. Description of the Related Art

Recently, signals delivered by each broadcasting station tend to change from an analog format to a digital format so as to provide high density pictures, and newly marketed television sets are implemented to be capable of outputting digital signals to meet with such a tendency. However, so as to receive such digital broadcasting, it is necessary for a television set to be provided with an exclusive tuner for receiving digital broadcasting. However, because many television sets are only provided with an analog tuner, it is requested that these sets be separately equipped with a device provided with a digital broadcasting receiving tuner (such a device is named “set-top box”). In addition, if two different tuners are installed in a television set, there is a problem in that both of the digital and analog broadcastings can be received only when an antenna is connected to each of the tuners.

Therefore, what is demanded so as to minimize user's inconvenience is to develop an analog and digital broadcasting receiver provided with a function of a digital tuner for receiving a digital broadcasting along with an analog tuner for receiving an analog broadcasting.

### SUMMARY OF THE INVENTION

Additional aspects and/or advantages of the invention will be set forth in part in the description which follows and, in part, will be obvious from the description, or may be learned by practice of the invention.

Accordingly, aspects of the present invention have been conceived to solve the above-mentioned problems occurring in the prior art, and an aspect of the present invention is to provide an analog and digital broadcasting receiver capable of receiving both of analog and digital broadcastings even if an antenna is connected to any one of a digital tuner and an analog tuner.

According to an aspect of the present invention, there is provided an analog and digital receiver including an analog broadcasting receiver for receiving and reproducing analog broadcasting signals, and a digital broadcasting receiver for receiving and reproducing digital broadcasting signals, which receivers are installed within a single housing, the analog and digital receiver comprising: an analog tuner for selecting an analog broadcasting, and a digital tuner for selecting a digital broadcasting, wherein an output stage of the digital tuner is wire-connected to an input stage of the analog tuner or an output stage of the analog tuner is wire-connected to an input stage of the digital tuner.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic perspective view showing an analog and digital broadcasting receiver according to an embodiment of the present invention;

FIG. 2 is a rear side elevational view of the analog and digital broadcasting receiver; and

FIG. 3 is a block diagram for describing the analog and digital broadcasting receiver according the embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

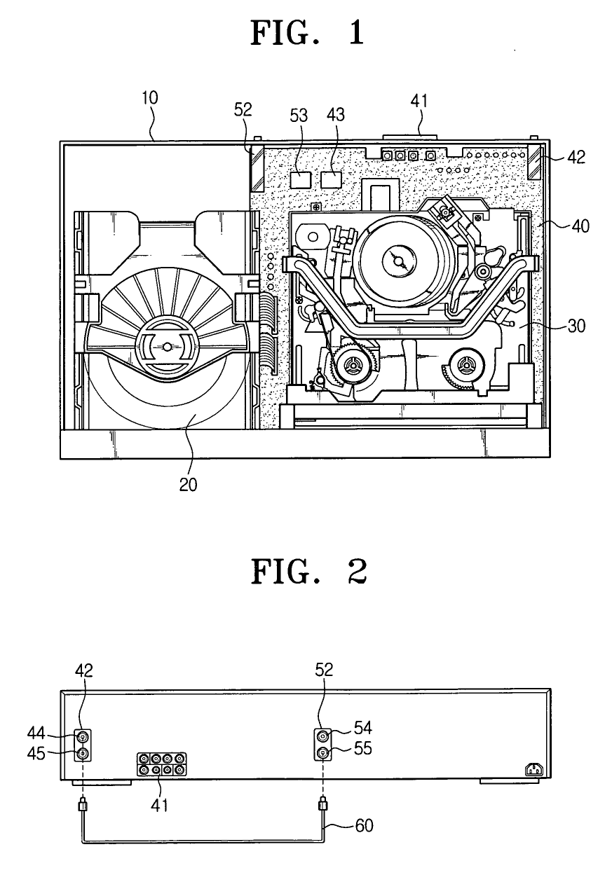

As shown in the embodiments in FIG. 1 and FIG. 2, an analog and digital broadcasting receiver is that formed by adding a digital tuner for digital broadcasting selection to a combo type system. Such an analog and digital broadcasting receiver comprises: a housing 10; a Digital Versatile Disc (DVD) deck 20 installed within the housing 10; a VCR deck 30 installed adjacent to the DVD deck 20 within the housing 10; a main board for controlling the DVD deck 20 and the VCR deck 30, wherein a video and sound outputting stage 41 and an analog tuner 42 for analog broadcasting selection are mounted on the main board 40; and a digital tuner 52 for digital broadcasting selection.

The DVD deck 20 and the VCR deck 30 are adapted to reproduce a DVD media and a video cassette media, wherein the DVD deck 20 and the VCR deck 30 are respectively connected to the main board 40 and operated by a first central processing unit 53, which respectively controls the DVD deck 20 and the VCR deck 30 in unison. However, it is understood that additional decks can be used instead of or in addition to the decks 20, 30 shown in FIGS. 1 and 2, such as decks which use other media (such as Bluray, Advanced Optical Discs, CDs), Digital Video Records or other drives using hard drives or other decks usable with magnetic, magneto-optical, semiconductor, and/or optical media.

A first central processing unit 53 is provided so as to control the digital tuner 52, which is intended for digital broadcasting selection.

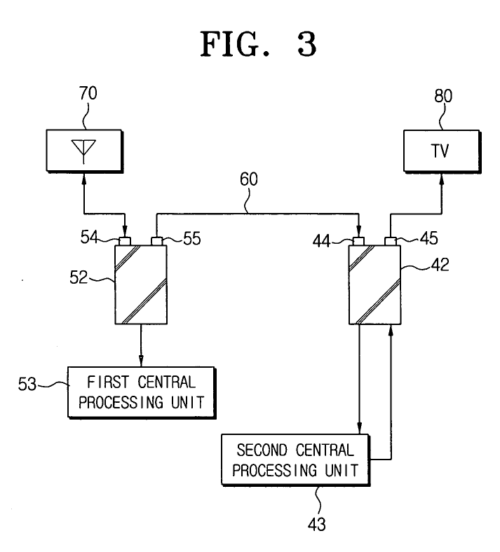

Meanwhile, as shown in FIG. 2, the digital tuner 52 and the analog tuner 42 are respectively provided with input stages 44, 54 connected to an antenna 70 (See FIG. 3), and output stages 45, 55 for outputting processed signals to a video output device such as a television set, a plasma display panel, an LCD, an OLED, or other types of screens.

According to an embodiment of the present invention, the digital tuner 52 and the analog tuner 42 are interconnected by a signal transmission 60, wherein the signal transmission part 60 comprises a coaxial cable capable of being connected to each of the input stages 44, 54 and the output stages 45, 55 but the present invention is not limited to this. By way of example, the digital tuner 52 and the analog tuner 42 may be interconnected by a circuit printed on the main board 40 on which the digital tuner 52 and the analog tuner 42 are mounted and/or using wireless technology.

As the digital tuner 52 and the analog tuner 42 are interconnected by way of the signal transmission part 60, if the antenna 70 (see FIG. 3) is connected any one of the input stages 44, 54, the user can select both the digital signals and the analog signals.

The inputted signals are post-processed by the first central processing unit 53 or the second central processing unit 43, thereby being converted into the signals which can be recognized by the video output device. The converted signals may be outputted from one of the output stages 55, 45 of the digital tuner 52 and the analog tuner 42 or through a video and sound output stage 41 separately provided on the main board 40.

FIG. 3 schematically shows the flow of information used for controlling the analog and digital broadcasting receiver according to the embodiment of the present invention. As shown in FIG. 3, the antenna 70 is connected to the input stage 54 of the digital tuber 52. In addition, the signal transmission part 60 formed by a coaxial cable is connected to the output stage 55 of the digital tuner 52 at one end thereof, in which the other end of the signal transmission part 60 is connected to the input stage 44 of the analog tuner 42.

If the connection is made in this manner, the user is allowed to select and receive either analog radio waves or digital radio waves by way of a predetermined control algorithm because the radio waves received by the antenna 70 contain digital radio waves as well as analog digital radio waves. Therefore, if the user selects the reception of the digital radio waves, only the digital broadcasting signals are selected from the radio waves received through the antenna 70, modulated in the digital tuner 52, from which video and sound signals are extracted, and then post-processed by the first central processing unit 53 mounted on the main board 40 to a state capable of being recognized by a video output device such as a television set.

Meanwhile, if the user selects the reception of the analog radio waves, the radio waves received through the antenna 70 pass the digital tuner 52 and are transmitted to the analog tuner 42 via the signal transmission part 60. From the radio waves transmitted to the analog tuner 42, only analog broadcasting signals are selected, modulated in the analog tuner 42, from which video and sound signals are extracted, and then post-processed by the second central processing unit 43 mounted on the main board 40 to a state capable of being recognized by a video output device such as a television set.

The post-processed signals may be outputted to a video output device 80 such as a television set, through the output stage 45 of the analog tuner 42 as shown in FIG. 3 or through the video and sound output stage 41 shown in FIG. 2.

Although not shown in the figures, it is also possible to connect the antenna 70 to the input stage 44 of the analog tuner 42, so that the digital broadcasting signals or the analog: broadcasting signals can be selected according to the broadcasting selection of the user.

While described in terms of an antenna 70, it is understood that the analog and digital signals can be input by other media, such as cable and/or satellite transmission. Further, it is understood that the set top box need not include either or both decks 20, 30 in all aspects of the invention, and that the set top box need not include any such deck according to aspects of the invention.

As described above, according to the inventive analog and digital broadcasting receiver, it is possible to receive both of analog and digital broadcastings if an antenna is connected to an input stage of any one of a digital tuner and an analog tuner. As a result, it is possible to cancel the inconvenience that a user has to connect the antenna to each of the tuners.

Although a few embodiments of the present invention have been shown and described, it would be appreciated by those skilled in the art that changes may be made in these embodiments without departing from the principles and spirit of the invention, the scope of which is defined in the claims and their equivalents.

1. A set-top box comprising:
a housing; and
a digital receiver disposed in the housing and including an analog broadcasting receiver section for receiving and reproducing analog broadcasting signals, and a digital broadcasting receiver section for receiving and reproducing digital broadcasting signals, the analog and digital receiver comprising:
an analog tuner for selecting the analog broadcasting signals; and
a digital tuner for selecting the digital broadcasting signals, wherein an output stage of the digital tuner is connected to an input stage of the analog tuner.

2. A set top box comprising:
a housing; and
an analog and digital receiver disposed in the housing and including an analog broadcasting receiver section for receiving and reproducing analog broadcasting signals, and a digital broadcasting receiver section for receiving and reproducing digital broadcasting signals, the analog and digital receiver comprising:
an analog tuner for selecting the analog broadcasting signals; and
a digital tuner for selecting the digital broadcasting signals, wherein an output stage of the analog tuner is connected to an input stage of the digital tuner.

3. The set-top box of claim 1, further comprising a video cassette recorder (VCR) wherein the analog turner transmits the selected broadcasting signal to the VCR for recording.

4. The set-top box of claim 1, further comprising a Digital Versatile Disc (DVD) player, wherein the digital turner transmits the selected broadcasting signal to the DVD player for recording.

5. The set-top box of claim 2, further comprising a video cassette recorder (VCR), wherein the analog tuner for selecting the analog broadcasting signal and transmitting the selected broadcasting signal to the VCR for recording.

6. The set-top box of claim 2, further comprising a Digital Versatile Disc (DVD) player, wherein the digital tuner for selecting the digital broadcasting signal and transmitting the selected broadcasting signal to the DVD player for recording.

7. The set-top box of claim 1, further comprising a wire which connects the output stage of the digital tuner to the input stage of the analog tuner.

8. The set-top box of claim 2, further comprising a wire which connects the output stage of the analog tuner to the input stage of the digital tuner.

9. The set-top box of claim 1, further comprising a drive in the housing which reproduces and/or records audio and/or video data with respect to a medium.

10. The set-top box of claim 2, further comprising a drive in the housing which reproduces and/or records audio and/or video data with respect to a medium.

11. The set-top box of claim 1, further comprising a printed circuit board which connects the output stage with the input stage.

12. The set-top box of claim 11, further comprising a main board on which the digital tuner and the analog tuner are mounted, wherein printed circuit board is printed on the main board.

13. The set-top box of claim 2, further comprising a printed circuit board which connects the output stage with the input stage.

14. The set-top box of claim 13, further comprising a main board on which the digital tuner and the analog tuner are mounted, wherein printed circuit board is printed on the main board.

15. A set-top box comprising:
a housing; and
a broadcasting receiver section disposed in the housing for receiving and reproducing digital broadcasting signals, the broadcasting receiver comprising:
an analog tuner for selecting and tuning to an analog broadcasting signal received by the set-top box; and
a digital tuner for selecting and tuning to a digital broadcasting signal received by the set-top box,
wherein an output stage of one of the digital tuner and the analog tuner is connected to an input stage of the other one of the digital tuner and the analog tuner so as to transfer a corresponding one of the audio and digital broadcasting signal from the one tuner to the another tuner.

16. The set-top box of claim 15, further comprising a drive in the housing which reproduces and/or records audio and/or video data with respect to a medium.

17. The set-top box of claim 16, wherein the drive comprises a Digital Versatile Disc (DVD) player.

18. The set-top box of claim 16, wherein the drive comprises a video cassette recorder (VCR).

19. The set-top box of claim 17, further comprising another drive in addition to the DVD which reproduces and/or records audio and/or video data with respect to another medium other than a DVD.

20. The set-top box of claim 15, further comprising a main board on which the digital tuner and the analog tuner are mounted, and a printed circuit board connecting the input and output stages is printed on the main board.
